(19) United States
(12) Patent Application Publication
(10) Pub. No.: US 2023/0255193 A1
(43) Pub. Date: Aug. 17, 2023

(54) SYSTEMS AND METHODS FOR EX VIVO PERFUSION OF VERTEBRATE TISSUE

(71) Applicant: THE TRUSTEES OF THE UNIVERSITY OF PENNSYLVANIA, Philadelphia, PA (US)

(72) Inventors: Matthew Winterton, Keller, TX (US); Lawrence Scott Levin, Philadelphia, PA (US); Edward Cantu, Ardmore, PA (US)

(73) Assignee: THE TRUSTEES OF THE UNIVERSITY OF PENNSYLVANIA, Philadelphia, PA (US)

(21) Appl. No.: 18/302,111

(22) Filed: Apr. 18, 2023

Related U.S. Application Data
(63) Continuation of application No. PCT/US21/55723, filed on Oct. 20, 2021.
(60) Provisional application No. 63/094,634, filed on Oct. 21, 2020.

(51) Int. Cl. A01N 1/02; G09B 23/28

(52) U.S. Cl. CPC A01N 1/0226; A01N 1/0247; G09B 23/285

(57) ABSTRACT

Systems and methods for an ex vivo tissue perfusion apparatus are provided. In certain embodiments, the disclosed subject matter includes a container to store ex vivo tissue, a plurality of tubes containing a perfusate, and a pump which cycles the perfusate through the ex vivo tissue. The perfusion apparatus can be configured for mobility and can be transported to active emergency situations in order to perform mobile perfusion of ex vivo tissues. In certain embodiments, the discloses subject matter contemplates a method for performing mobile profusion of ex vivo tissue in emergency situations, for example, active warzones. In certain embodiments, the profusion apparatus can be used as part of a method of training for doctors in the reattachment of limbs or other extremities that have been amputated.

### CROSS-REFERENCE TO RELATED APPLICATIONS

This application is a Continuation of International Patent Application No. Application No. PCT/US2021/055723, filed Oct. 20, 2021, which claims priority to U.S. Provisional Patent Application Ser. No. 63/094,634, filed Oct. 21, 2020, the contents of which are incorporated by reference herein in their entireties.

### BACKGROUND

Over the last two decades, traumatic battlefield injuries sustained in the Middle East and other active warzones, such as in Afghanistan, have brought advancements in extremity trauma care. Despite certain advances, overall amputation rates following blast injuries remain high, in part because of an inability to maintain the viability of tissues in amputated extremities for the time required for reattachment.

One method of extending the viability of ex vivo tissue, including, e.g., lungs, hearts, and extremities, is by perfusion machines. Such machines can cycle a variety of fluids, such as blood substitutes, heparin, dextrose, and other perfusion substances, through the ex vivo tissue and preserve these tissues beyond their ordinary life span.

Certain apparatuses perform perfusion of ex vivo organs, such as hearts and lungs. However, they can suffer from certain weaknesses which limit their applicability to emergency situations. For example, due to their size, certain apparatus cannot be deployed rapidly in traumatic situations and cannot be moved outside limited medical facilities designed for their operation and storage.

Additionally, certain apparatus perform perfusion of ex vivo organ, such as the lung and the heart, and thus cannot contain or preserve certain ex vivo tissues, such as arms or legs, which can be more commonly amputated in traumatic circumstances or warzone conditions.

Accordingly, there exists a need for a mobile perfusion apparatus which is capable of being deployed to a plurality of different environments and which can also preserve a variety of different ex vivo tissues, including at least extremities.

### SUMMARY

Techniques for ex vivo perfusion of vertebrate tissue are disclosed herein.

In certain embodiments, the disclosed subject matter can include a perfusion apparatus for preservation of an ex vivo tissue having a plurality of external features and a plurality of internal features. The external feature can include, at least, a rectangular container having an aperture sized to be slightly larger than a target human extremity. The internal feature can include, at least, a pump configured to control the flow of a perfusate through a human extremity placed within the perfusion apparatus.

In certain embodiments, the perfusion apparatus can also include other external features. For example, the rectangular container can include a window or other transparent section which allows for visual inspection of the tissue. The aperture can also include a movable door which can be opened to allow entry of the tissue or closed in order to secure the tissue within the rectangular container.

In certain embodiments, the rectangular container can also be configured for mobility by including, for example, wheels or other mechanisms on the bottom of the container to facilitate portability and transport. The rectangular container can also include handles which can be used to carry the perfusion apparatus.

The rectangular container can also include an external display, configured to show functional status of the perfusion apparatus, including data related to perfusion and flow parameters, temperature, pressure and tissue oxygenation. This external display can also include a plurality of buttons configured to accept user input. User input can be configured to control various functions of the perfusion apparatus, including at least pump activation, flow parameters of the perfusate, and internal temperature. In certain embodiments, the rectangular container can also include a warning system, in the form of a speaker or a light, which can provide a visible or audible alarm in the event of a malfunction or failure of the perfusion apparatus or any components therein.

In certain embodiments, the perfusion apparatus can include additional features, including at least one of a rechargeable and removable battery configured to supply power to the perfusion apparatus and a power cord configured to provide AC power. The additional features can also include entry ports configured to allow for external sampling of the perfusate and the inclusion of various additives to the perfusate, e.g., heparin, antibiotics, saline, steroids, Steen Solution, blood alternatives, UW solution, Celsior and other perfusates.

In certain embodiments, the perfusion apparatus can include an external collection system. The external collection system can include a chemically cooled chamber, configured to contain the ex vivo tissue before it is inserted into the perfusion apparatus. The external collection system can be transported with the perfusion device in order to assist with the transport and containment of ex vivo tissue.

In certain embodiments, the perfusion apparatus can include a sterile insert configured to maintain the sterility of the ex vivo tissue to be preserved. The sterile insert can be configured to be removable, allowing for reuse of the apparatus and replacement with another sterile insert. In certain embodiments, the sterile insert can be sloped in one direction to allow for waste products to drain outside of the perfusion apparatus or, alternatively, to recycle the perfusate. The sterile insert can further include a removable cushioning mechanism, e.g., memory foam or gel padding, configured to cushion the ex vivo tissue and prevent necrosis or other deterioration. The sterile insert can also include a plurality of apertures or holes configured to receive tubing and cannulas connecting the pump and the ex vivo tissue and delivery the perfusate to and from the ex vivo tissue. The perfusion apparatus can include a purse string style suture integrate, configured to cannulate a wide variety of vessels.

In certain embodiments, the perfusion apparatus can include a plurality of quick connect components. The quick connect components can attach the perfusion apparatus to the ex vivo tissue without sutures and be easily connected or disconnected from the tissue. The quick connect components can be in the form of an infusion cannula which can be inserted into the veins and arteries of the ex vivo tissue. The infusion cannula can further be connected to the ex vivo tissue with a plastic band, which secures the infusion cannula to the vein or artery by, at least, applying pressure to the outside of the vein or artery.

In certain embodiments, the perfusion apparatus can include monitoring equipment configured to measure various parameters of the perfusion apparatus. For example, the perfusion apparatus can include a pulse oximetry apparatus configured to continuously monitor oxygen saturation of the ex vivo tissue, a temperature sensor to configured to continuously monito the ambient temperature of the rectangular container, a perfusate sensor configured to continuously or intermittently sample the perfusate. The perfusate sensor can be further configured to perform chemical analysis and/or measure hemoglobin or lactate concentration of the perfusate. The monitoring equipment can also be configured to output and display relevant data on, for example, the external display of the perfusion apparatus.

In certain embodiments, the perfusion apparatus can also include mechanical components. For example, the pump may include a filtering mechanism. The pump may also include an oxygenation component configured to oxygenate the perfusate as needed. A waste reservoir can also be included, configured to collect and store a plurality of additives, for example, antibiotics, heparin, tPA, saline, blood product, and perfusate.

In certain embodiments, the disclosed subject matter provides methods for perfusing ex vivo tissues. An example method includes transporting the perfusion apparatus to a remote environment, for example an active warzone environment, collecting ex vivo tissue that has been damaged in a traumatic event, inserting the ex vivo tissue into the perfusion apparatus in order to extend the viability time of the tissue, transporting the perfusion apparatus containing the ex vivo tissue to a medical location, such as a remote field hospital or similar, and repairing the ex vivo tissue, for example by reattaching the limb.

In certain embodiments, the method for perfusing ex vivo tissue includes improvements to Vascularized Composite Allotransplantation (VCA) procedures. VCA can involve the transplantation of tissue from a deceased donor to a recipient who has experienced a traumatic injury. The disclosed subject matter can extend the time available for performing VCA, as it can increase the ischemia time of ex vivo tissue, enabling the tissue to be transported across significant distances. This can increase potential VCA recipient access to donor tissue pools and increase the likelihood of successful single transplantation and/or reconstruction.

In certain embodiments, the method for perfusing ex vivo tissue can be used to train doctors and other medical professionals to perform limb reattachment procedures. The perfusion apparatus can provide a realistic training environment that cannot be otherwise simulated using lab equipment or prosthetic materials. For example, an extremity, such as an arm or a leg, may be placed inside the perfusion apparatus and attached to the pump for perfusion. Once attached, a part of the extremity, such as a hand or foot, may be amputated. A trainee could then reattach the severed part of the extremity and the complete extremity evaluated for viability. Various components, such as a tourniquet, could be included in the system in order to control blood flow and further simulate real life conditions.

The accompanying drawings, which are incorporated and constitute part of this disclosure, illustrate certain preferred embodiments of the invention and serve to explain the principles of the disclosed subject matter.

### BRIEF DESCRIPTION OF THE DRAWINGS

FIG. 1 is a diagram illustrating a perfusion apparatus for ex vivo tissue according to certain embodiments of the present disclosure.

FIG. 2 illustrates an exemplary external display for a perfusion apparatus.

FIG. 3 illustrates an exemplary external display for a perfusion apparatus, including a plurality of input configured to control the perfusion apparatus.

FIG. 4 depicts a prototype perfusion apparatus in operation according to certain embodiments of the present disclosure.

### DETAILED DESCRIPTION

The disclosed subject matter relates to devices and methods for the perfusion of ex vivo tissue. The discloses subject matter can cycle perfusate through a variety of ex vivo tissues, such as arms, legs, and other extremities. The disclosed subject matter can be transported to emergency sites, such as warzone environments, to enable perfusion of ex vivo tissue in a variety of environments. The discloses methods can also be used to assist with training of medical professionals.

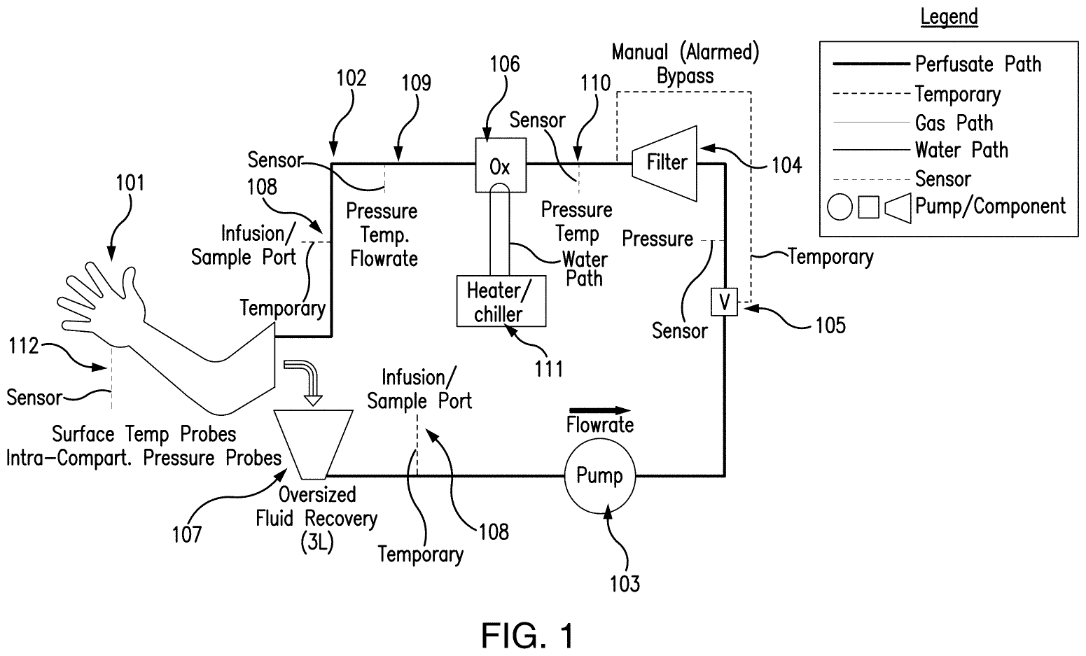

FIG. 1 is a diagram illustrating an exemplary perfusion apparatus according to the disclosed subject matter. An ex vivo tissue 101 can be connected to at least one vessel or tube 102 which is coupled to a pump 103. The pump 103 is configured to cycle a perfusate through the vessel or tube 102 and the ex vivo tissue 101. Once the perfusate is cycled through the ex vivo tissue 101 it can be reclaimed with a fluid recovery apparatus 107 which inserts the perfusate into the vessel or tube 102 to continue being cycled by the pump 103. The perfusion apparatus can also include other components which improve functioning of the device. These components can include sensors 112, 109, 110 for detecting system characteristics such as temperature, pressure, and flow rate, an oxygenator 106 configured to oxygenate the perfusate, a temperature regulator 111 configured to control the temperature of the perfusate, a plurality of infusion ports 108 which can allow a user to infuse a plurality of additives to the perfusate, and a warning system 105 configured to alert the user to a malfunction of failure in the pump 103 or other components of the system.

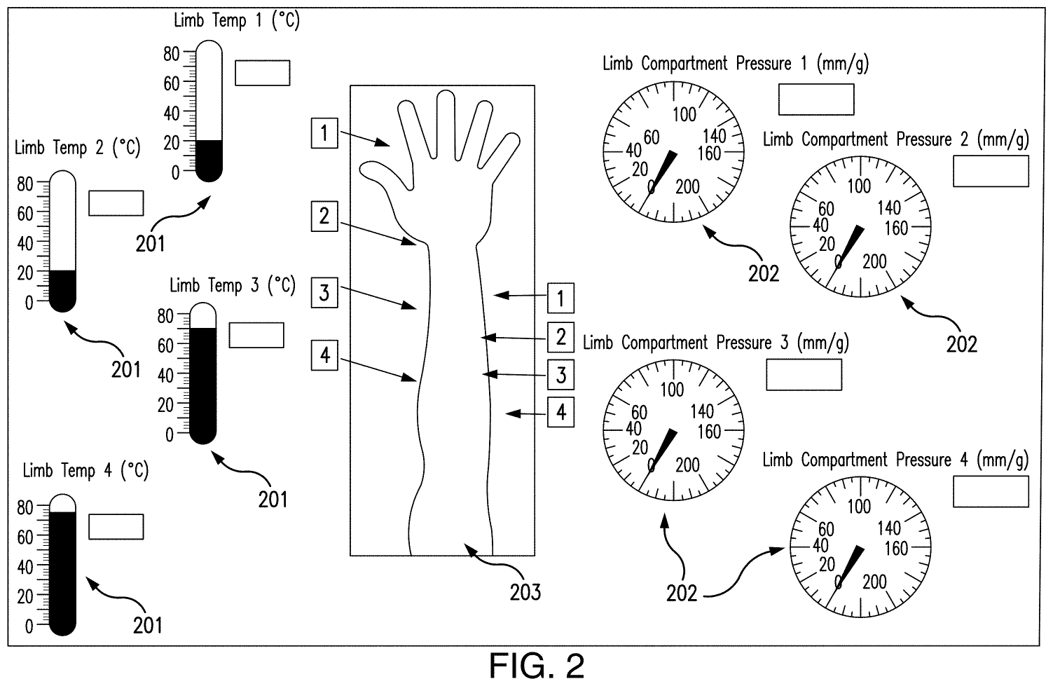

FIG. 2 illustrates an exemplary external display for a perfusion apparatus. The display is configured to collect information from a plurality of sensors (e.g. 112, 109, 110) located on ex vivo tissue and display the results for a user. The display can include temperature indicators 201 and pressure indicators 202.

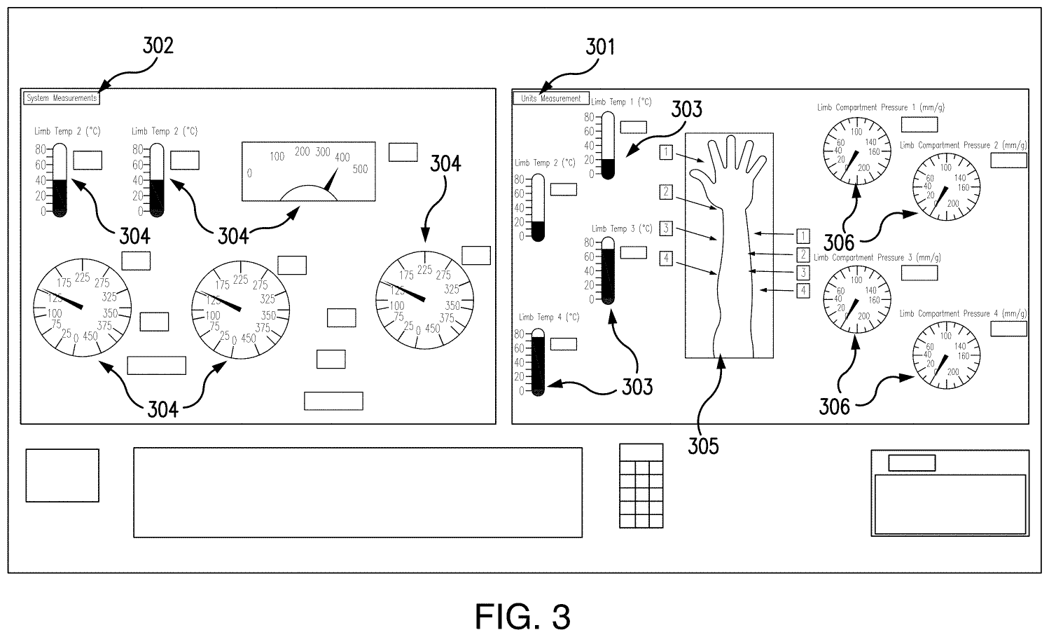

FIG. 3 illustrates an exemplary external display for a perfusion apparatus configured to display information related to the ex vivo tissue 305 and the perfusion apparatus. The display can collect information from a plurality of sensors (e.g., 112, 109, 110) and display the results for a user. These results can include information 304 related to the perfusion apparatus itself and information 303, 306 related to the ex vivo tissue 305 contained within the perfusion apparatus.

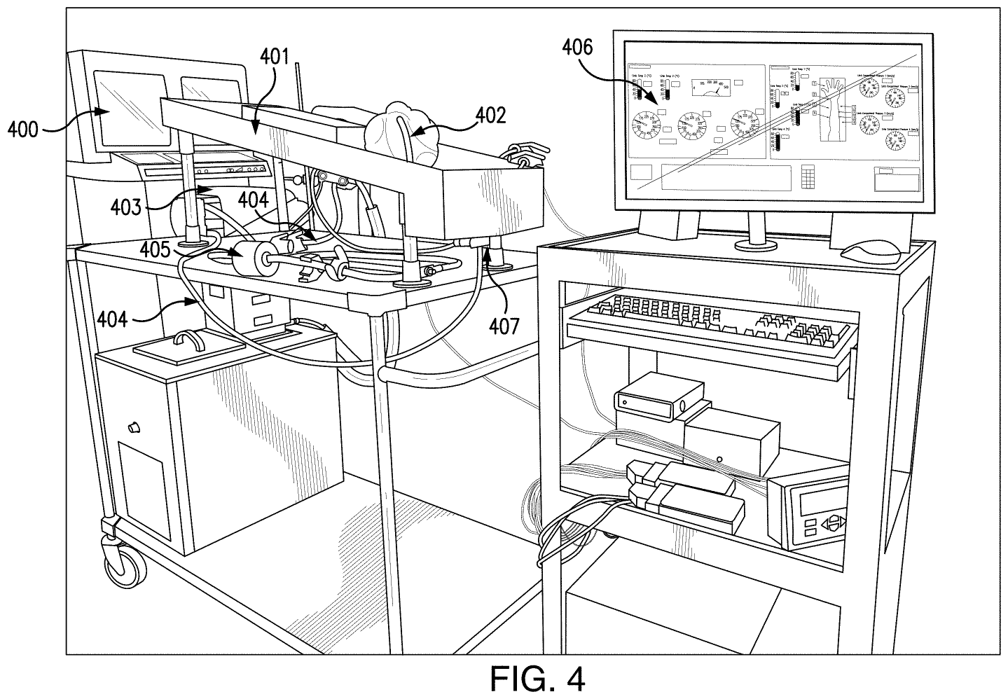

FIG. 4 illustrates a prototype perfusion apparatus 400 according to the disclosed subject matter. A rectangular container 401 stores the ex vivo tissue 402 for perfusion. At least one tube or another vessel 404 is attached to the ex vivo tissue 402. A perfusate is contained within the tube or vessel 404 and cycled through the ex vivo tissue 402. The rectangular container 401 is configured at an angle such that perfusate which exits the ex vivo tissue 402 is collected in a reservoir 407 at one side of the rectangular container 401, where the perfusate is collected and cycled into tube or vessel 404. Cycling is performed by a pump 403 which moves the perfusate through the tube or vessel 404 and through the ex vivo tissue 402. An external display 406 can also be coupled to the apparatus, configured to display and control a plurality of different characteristics of the perfusion apparatus 400, including temperature and pressure.

What is claimed is:

1. A device for perfusion of an ex vivo target tissue comprising:
a rectangular container having at least one aperture with a size larger than a size of the ex vivo target tissue;
a pump adapted to be coupled to the ex vivo target tissue;
a plurality of vessels configured to be coupled to the pump and the ex vivo target tissue;
a perfusate contained within at least one of the plurality of vessels; and
a sterile insert adapted to be coupled to a side of the rectangular container.

2. The device of claim 1, wherein the perfusate further comprises one or more additives selected from the group consisting of antibiotics, heparin, tPA, saline, and blood products.

3. The device of claim 1, wherein the rectangular container further comprises:
a plurality of wheels located along a first side of the rectangular container; and
a plurality of handles located along at least a second side of the rectangular container different from the first side.

4. The device of claim 1, wherein the device further comprises an external display configured to display data related to the device, including perfusion parameters, flow parameters, temperature, or tissue oxygenation.

5. The device of claim 4, wherein the external display comprises a plurality of input buttons configured to accept user input,
wherein the user input is configured to control a plurality of functions, including pump activation, perfusate parameters, flow parameters, or temperature.

6. The device of claim 1, wherein the sterile insert further comprises a plurality of apertures to receive the plurality of vessels.

7. The device of claim 6, wherein the sterile insert further comprises a purse string style suture integrate, configured to cannulate the plurality of vessels.

8. The device of claim 1, wherein the device further comprises a rechargeable battery configured to supply power to the device; and
wherein the rechargeable battery is removable.

9. The device of claim 1, wherein the rectangular container further comprises a warning system configured to produce a warning upon detection of a failure of the device.

10. The device of claim 1, wherein the pump further comprises a filter configured to remove contaminants from the perfusate.

11. The device of claim 1, wherein the rectangular container further comprises a perfusate sensor, configured to perform a chemical analysis of the perfusate.

12. The device of claim 1, wherein the device further comprises a reservoir located proximate one side of the rectangular container and coupled to the plurality of vessels.

13. The device of claim 1, wherein the device further comprises an external collection apparatus, configured to chemically cool the ex vivo target tissue before attachment to the plurality of vessels.

14. A method of preserving ex vivo tissue using a perfusion apparatus comprising:
transporting the perfusion apparatus to an emergency situation site;
inserting an ex vivo tissue into the perfusion apparatus;
transporting the perfusion apparatus with the ex vivo tissue to a medical facility;
wherein the perfusion apparatus further comprises:
a rectangular container having at least one aperture with a size larger than a size of the ex vivo tissue;
a pump;
a plurality of vessels configured to be coupled to the pump and the ex vivo tissue;
a perfusate contained within at least one of the plurality of vessels; and
a sterile insert.

15. The method of claim 14, wherein the emergency situation site is an active warzone and the medical facility is a mobile hospital facility.

16. The method of claim 14, wherein the perfusion apparatus is sized so as to be transported using a variety of vehicles, including a car, a plane, a helicopter, and a ship.

17. A method of training medical professionals using a mobile perfusion apparatus comprising:
storing an ex vivo tissue in a perfusion apparatus;
preparing a test for medical professionals which includes at least one test portion dedicated to reattachment of an extremity;
performing the test for medical professionals by presenting the medical professionals with the perfusion apparatus containing the ex vivo tissue;
after the test, removing the reattached ex vivo tissue;
storing the removed ex vivo tissue in the perfusion apparatus to be used in later tests.

18. The method of claim 17, further comprising the steps of:
inserting an extremity into the perfusion apparatus;
attaching the extremity to the perfusion apparatus;
amputating the target ex vivo tissue from the extremity;
performing simulation functions on the extremity;
reattaching the target ex vivo tissue to the extremity.
